(19) United States
(12) Patent Application Publication
(10) Pub. No.: US 2003/0173232 A1
(43) Pub. Date: Sep. 18, 2003

(54) Method to increase the sensitivity of a carbon electrode

(76) Inventors: Jurgen Schulein, Hemhofen (DE); Christine Kugler, Spardorf (DE); Burcu Meric, Erlangen (DE); Bjorn Grassl, Nurnberg (DE); Georg Bauer, Nurnberg (DE); Andre Josten, Nurnberg (DE); Hans Kosak, Bonn (DE); Jorg Hassmann, Erlangen (DE)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/324,290

(22) Filed: Dec. 19, 2002

(30) Foreign Application Priority Data
Mar. 14, 2002 (DE) DE 102 11 741.1

(51) Int. Cl. G01N 27/26

(52) U.S. Cl. 205/775; 205/794.5; 204/403.15

(57) ABSTRACT

The invention relates to a method to increase the sensitivity of a carbon electrode for electrochemically detecting an analyte without electrochemically conditioning the carbon electrode, wherein the method comprises treating the carbon electrode with an ionic detergent which is in solution, wherein the detergent is not incorporated in a coating of the electrode.

### CROSS REFERENCE TO RELATED APPLICATIONS

This application claims priority under 35 U.S.C. §119(a) of German Application Number DE 102 11 741.1, filed Mar. 14, 2002.

### TECHNICAL FIELD

This invention relates to electrochemically detecting an analyte, and more particularly to methods to increase the sensitivity of a carbon electrode for electrochemically detecting an analyte.

### BACKGROUND

Electrochemical methods can be employed for studying and specifying redox-active analytes. The analytes are reacted at a working electrode. Currentless voltage measurement is carried out using a reference electrode. The current flowing via the working electrode or the difference in voltage between working electrode and reference electrode is controlled via a counter-electrode. Analytes can be electrochemically detected either by potentiometry or amperometry. In a potentiometric measurement protocol, the voltage dropped across the working and reference electrodes is measured in a time-dependent manner. During this measurement, a controlled current profile can be applied. In the case of a constant current, this measurement is referred to as constant current chronopotentiometry. The study by means of constant current chronopotentiometry of analytes adsorbed or complexed to a working electrode is also referred to as constant current chronopotentiometric stripping analysis, or frequently only as chronopotentiometric stripping analysis (CPSA). The cathodic constant current potentiometric stripping analysis comprises a method in which successive analytes are oxidized by applying a positive current. These voltage-dependent oxidation reactions make it possible to draw conclusions about oxidizable analytes. The anodic constant current potentiometric stripping analysis comprises a method in which a negative current is applied in order to be able to draw conclusions from the voltage profile obtained about reducible analytes.

In an amperometric measurement protocol, the voltage dropping between reference electrode and working electrode is modified via a counterelectrode according to a predefined protocol. At the same time, the current flowing via the working electrode is measured. Depending on the voltage applied, redox-active analytes can be reduced or oxidized. Evaluation of the current profile makes it possible to draw conclusions about the analytes. An electrochemical measurement method using a stationary working electrode, in which a current-voltage characteristic is recorded, is also referred to as voltammetry, with the corresponding graphical representation being referred to as voltammogram. For very sensitive measurements of redox processes, special measurement protocols have been developed in which capacitive processes that take place in addition to the redox processes and influence the measurements are substantially suppressed. A very efficient measurement protocol is differential pulse voltammetry (DPV).

Wang et al. (1998, Analytica Chimica Acta, 197-203) describe an electrochemical detection of DNA hybridization. In this case, an inosine-substituted, guanine-free DNA probe is immobilized on a carbon paste electrode. Formation of DNA hybrids with the immobilized DNA probe is detected chrono-potentiometrically via formation of a guanine oxidation peak of the hybridized DNA. This method has the disadvantage that the electrode surface must be renewed for each detection, i.e., the DNA probe must again be immobilized. This leads to inadequate reproducibility of the results obtainable therewith. In this method, the DNA probe is immobilized by nonspecific binding to the electrode. Disadvantageously, this causes partial loss of binding capacity of the DNA probes. The method has the further disadvantage that, owing to the sensitivity of the electrode, it is not possible to choose stringent hybridization conditions, resulting in a large proportion of nonspecific hybridizations.

Furthermore, Ontko et al., (1999, Inorg. Chem., 1842-1846) describe coating the surface of a “glassy carbon” electrode with a thin film. Such film contains rubidium-bipyridine complexes as mediators that cause catalytic amplification of the current resulting from oxidation of guanine residues in DNA. Mediators of this kind have the disadvantage of generating a strong background signal during electrochemical detection of a DNA. Prior to applying the film, the electrode is first polished thoroughly. The rubidium-bipyridine complexes are then applied by repeated electropolymerization. DNA binds to the coated electrode via a carbodiimide bond in the process, the carboxyl groups present on the surface are activated in order to react subsequently with an amino group of the DNA. The amino group is preferably an amino group of a linker of a single-stranded DNA. However, the nucleotide amino groups can also form carbodiimide bonds. These nucleotides are then no longer available for later hybridization.

Carbon electrodes are usually pretreated prior to electrochemical detection in order to increase sensitivity of the electrodes and reproducibility of the detection. For this purpose, the electrode surface may be mechanically polished. This is, however, impossible when the electrodes have been coated with a molecule required for detection. Furthermore, the electrodes are usually electrochemically conditioned. In this connection, redox-active substances present on the electrodes are oxidized in order to prevent them from interfering with the later electrochemical detection. At the same time, the electrode surfaces are hydrophilized so that the electrodes can be wetted by liquid. The method is complicated and can be automated only with difficulty. Another disadvantage is that molecules immobilized on the electrode which are intended to react with a substance to be analyzed can likewise be oxidized in the process. Thus, for example, guanidine residues present in an immobilized DNA are oxidized, thereby impairing the hybridization properties of the DNA.

WO 01/13103 A1 discloses electrodes having a selectively permeable coating of an oxidised phenolic compound on their surface. The coating has a surface-active agent incorporated therein. The method to produce the electrode is labor-intensive and expensive.

It is an object of the present invention to provide a method for the treatment of a carbon electrode, which avoids the abovementioned disadvantages. In particular, neither mechanical polishing nor electrochemical conditioning should be required. Another object of the invention is to provide a carbon electrode treated correspondingly and a use of the carbon electrode.

### SUMMARY

In one aspect, the invention features a method to increase the sensitivity of a carbon electrode for electrochemically detecting an analyte without electrochemically conditioning the carbon electrode. The method includes the steps of treating the carbon electrode with an ionic detergent, wherein the ionic detergent is in solution, and wherein the detergent is not incorporated in a coating of the electrode.

The concentration of the detergent can be from about 0.1% w/v to 20% w/v (e.g., 1% w/v to 15% w/v). A critical micellar concentration of the detergent in water can be less than 11 mmol/L (e.g., less than 5 mmol/L, or less than 3 mmol/L). A representative detergent is sodium dodecyl sulfate (SDS).

By way of example, the carbon electrode can be coated with a substance. The substance can be an electrochemically substantially inert substance such as silane. A representative silane is silane is 3-(glycidyloxypropyl) trimethoxysilane.

In addition, a molecule can be bound to the carbon electrode. Such a molecule can be bound to the substance. A molecule can be bound directionally. For example, the directionally bound molecule can be bound to the carbon electrode at one end of the molecule. Such a molecule can be bound covalently. Generally, the quotient of the amount of the molecules bound directionally and the amount of the molecules that are not bound directionally is greater than 1 (e.g., greater than 3).

A molecule can be bound to the carbon electrode in the presence of a competitor. Typical competitors include a protein and an amino acid. The molecule can be a capture molecule that specifically binds the analyte. Representative capture molecules include nucleic acids, nucleic acid analogs, ligands, haptens, peptides, proteins, sugars, or lipids. Such nucleic acids can be single-stranded. Single-stranded nucleic acids can include at least one nucleotide having a modified base, wherein the modified base generates a signal during electrochemical detecting that is different from that generated by nucleotides of the analyte. Representative modified bases are inosine or 8-oxoguanine. Generally, the single-stranded nucleic acid has no guanine and/or adenine residues.

The carbon electrode can be treated with the ionic detergent prior to, during, or after binding of the analyte to the capture molecule. Representative carbon electrodes include a pencil electrode, a glassy carbon electrode, a pyrolytic graphite electrode or a plastic composite electrode. By way of example, the carbon electrode can be a graphite-containing polycarbonate electrode.

The carbon electrode can be additionally treated with a chaotropic agent such as urea or guanidine hydrochloride.

In another aspect, the invention features a carbon electrode for electrochemically detecting an analyte, wherein the electrode has been treated according to the methods of the invention.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### DESCRIPTION OF DRAWINGS

FIG. 1 depicts the ratio of amino terminally bound nucleic acid to nucleic acid bound in an undefined manner.

FIG. 2 depicts an amount of nucleic acids nonspecifically bound to uncoated pencil electrodes, determined by means of DPV.

FIG. 3 depicts a DPV voltammogram of a silanized electrode and a non-silanized electrode.

FIG. 4 depicts an amount of nucleic acid adsorbed to electrodes after an aftertreatment with 10%, 5% and 1% SDS, determined by means of DPV.

FIG. 5 depicts a DPV voltammogram of polyinosine.

FIG. 6 depicts a DPV voltammogram of guanine oxidation of complementary nucleic acids bound by means of capture molecules.

FIG. 7a depicts cyclovoltammograms recorded by polycarbonate/graphite electrodes prior to and after treatment with 10% SDS.

FIG. 7b depicts a CPSA of a herring sperm DNA solution, carried out using a polycarbonate/graphite electrode after treatment thereof with SDS.

FIGS. 8a,b depict a comparison of CPSA signals generated by polycarbonate/graphite and pyrolytic graphite electrodes, respectively.

Like reference symbols in the various drawings indicate like elements.

### DETAILED DESCRIPTION

The invention relates to a method to increase the sensitivity of a carbon electrode for electrochemically detecting an analyte without electrochemically conditioning the carbon electrode. The invention further relates to a carbon electrode. In this connection, a carbon electrode means any electrode that contains elemental carbon. The analyte is generally a biomolecule, such as a nucleic acid.

In accordance with the invention, a method to increase the sensitivity of a carbon electrode for electrochemically detecting an analyte without electrochemically conditioning the carbon electrode is provided. The method comprises treating the carbon electrode with an ionic detergent that is in solution, wherein the detergent is not incorporated in a coating of the electrode. After treatment, the carbon electrode is suitable for electrochemically detecting the analyte at least once. The carbon electrode either is made functional by the treatment in the first place or retains its functionality during treatment. In order to maintain functionality, the carbon electrode may be selected so as not to be attacked by the detergent in its substance. However, it is also possible to choose the length of treatment, concentration and/or detergent in such a way that, after treatment, it is still possible for the carbon electrode to electrochemically detect the analyte at least once. For the purposes of the present invention, detecting means also quantifying.

Surprisingly, the method of the invention was found to make it possible to increase the sensitivity of the carbon electrode and reproducibility of the detection to a level which had previously been possible only by using electrochemical conditioning or polishing the carbon electrode. Using the carbon electrodes treated according to the invention in a plurality of independent measurements can even result in a lower standard deviation than is possible using electrochemically conditioned carbon electrodes. In the case of plastic composite electrodes, in particular graphite-containing polycarbonate electrodes, it was furthermore found that only treatment with the ionic detergent but not electrochemical conditioning made it possible to achieve sufficient sensitivity for detecting DNA. To increase the sensitivity of the electrode it is not necessary to incorporate the detergent in a coating of the electrode. The method is cheaper and easier to perform than a method, where a detergent has to be incorporated in a coating of an electrode.

The method has a further advantage in that molecules bound to the carbon electrode, such as, for example, DNA, can remain fully functional and, for example, do not lose binding capacity due to oxidation.

Previously, the use of detergents in carbon electrodes was avoided because of fears that this might block the electrodes for desired bonds. Furthermore, Wang et al. (1998, Analytical Chimica Acta, page 201, left column) stated that a detergent such as Tween as blocking agent impairs the reproducibility of a hybridization signal. Electrochemical detection methods are generally very sensitive to additional, in particular ionic, components of the solution in which detecting takes place. It is known, for example, that the ionic detergent sodium dodecyl sulfate (SDS) can block a mercury electrode in such a way that the latter can no longer be used for electrochemical detecting. Owing to the intrinsic property of a detergent of binding both to hydrophobic and hydrophilic surfaces, the skilled worker would fear that a detergent will also bind to the surface of a carbon electrode and interfere with electrochemical detection. When treating the electrode with the detergent prior to electrochemical detecting, it is a concern that the detergent is attached to the surface so tightly that even a washing step cannot remove it therefrom. Even with a pretreatment, the skilled worker therefore will assume that there is the risk of a disruption of electrochemical detecting. Surprisingly, however, a negative influence of this kind has proven not to be present.

It is particularly advantageous for the concentration of the detergent to be from 0.1% w/v to 20% w/v, in particular 1% w/v to 15% w/v. The detergent is preferably in an aqueous solution and the carbon electrode is treated by immersing it in the solution and subsequent incubation.

A detergent that has proven to be advantageous has a critical micellar concentration in water of less than 1.1 mmol/L, in particular less than 5 mmol/L, preferably less than 3 mmol/L. The detergent is preferably sodium dodecyl sulfate (SDS).

In one exemplary embodiment, the carbon electrode is coated with a substance. Such a substance can be an electrochemically substantially inert substance. An inert substance here means a substance that can generate no electrochemical signal, in particular in a measurement range relevant for detecting the analyte. A coating with such a substance, in contrast to a coating with a substance containing electrochemically active groups, does not cause any background signals that make detecting of a signal specific for the analyte more difficult. The general advantage of a coating is the possibility of it providing specific chemical groups on the surface of the carbon electrode, to which in turn other molecules can bind. Treatment with the ionic detergent prior to coating with the substance is particularly advantageous for the subsequent properties of the carbon electrode. The substance is preferably a silane, for example, 3-(glycidiyloxypropyl) trimethoxysilane.

In a particular embodiment, a molecule is bound to the carbon electrode. A molecule can be specifically bound to the substance. In this connection, the detergent may be treated prior to, during and/or after binding the molecule to the substance. Storing the carbon electrode in a solution containing the detergent, after binding of the molecule until detecting, is particularly advantageous. This makes it possible to use the carbon electrode immediately at any time, without having to subject it to an additional treatment immediately before detecting. Storing the carbon electrode in a solution containing the detergent after detecting ensures reusability of the carbon electrode.

The molecule is preferably bound directionally, in particular at one of its ends. The terminal binding can enable the molecule to retain its full functionality, in particular its binding capacity. Thus, it is possible, for example, for a terminally bound DNA or for an antibody bound at the end of its Fc portion, to retain its specific binding capacity. The molecule may be bound covalently to the carbon electrode or to the substance. This makes it possible to treat the carbon electrode with very powerful detergents without the molecule detaching from the carbon electrode.

It is advantageous if the quotient of the amount of those molecules which are bound directionally, in particular covalently, to the carbon electrode or the substance and the amount of those molecules which are bound in a different way to the carbon electrode or the substance is greater than 1, preferably greater than 3. Frequently, this can be difficult to achieve. If, for example, covalent binding is via a carbodiimide bond, covalent bonds may be formed not only with a terminal amino group intended therefor, but also via the amino groups of the nucleic acid bases, in particular of guanine. However, undesired covalent binding can be suppressed by binding the molecule in the presence of a competitor. For example, a competitor can be a protein or an amino acid. The competitor is a molecule that competes with the molecule for the undesired covalent binding. In this case, the competitor should be chosen so that its reactivity when forming a covalent bond is lower than that of the chemical group whose covalent binding is desired. At the same time, however, its reactivity should be higher than that of the chemical group whose covalent binding is not desired.

The molecule is preferably a capture molecule that specifically binds the analyte. Such a capture molecule may be a nucleic acid, a nucleic acid analog, a ligand, a hapten, a peptide, a protein, a sugar or a lipid. Such a nucleic acid can be single-stranded. The single-stranded nucleic acid preferably contains at least one nucleotide having a modified base such as inosine or 8-oxoguanine, which, during electrochemical detecting, generates a signal different from that generated by nucleotides of the analyte. “Different” means that the signal generated by the nucleotide having a modified base is distinguishable from that generated by nucleotides of the analyte. This can prevent the capture molecule from providing bases which themselves, during electrochemical detecting of bases of a nucleic acid bound by the capture molecule, generate an electrochemical signal in the measurement range relevant to the latter bases. 8-Oxoguanine preferably forms a base-pair with adenine and may therefore take the place of thymine in the nucleic acid. Inosine, which can form a base pair, inter alia, with cytosine, may take the place of guanine in the nucleic acid. This preserves the binding capacity of the nucleic acid even under oxidizing conditions. The oxidation signal generated by inosine can be distinguished clearly from that of guanine. Since mainly adenine and/or guanine residues are electrochemically detected, it is particularly advantageous for the single-stranded nucleic acid not to have any guanine and/or adenine residues.

In one exemplary embodiment, the carbon electrode is treated with the detergent prior to, during or after binding of the analyte to the capture molecule. Treatment with the detergent can prevent and/or remove nonspecific binding of substances interfering with detection of the analyte. Detecting in the presence of the detergent is also possible. Previously, it has been assumed that the presence of the detergent interferes with detecting and impairs reproducibility of the measurement.

The carbon electrode may be a pencil electrode, a glassy carbon electrode, a pyrolytic graphite electrode or a plastic composite electrode. A representative electrode is a graphite-containing polycarbonate electrode. A pencil electrode is a conventional pencil. The graphite-containing polycarbonate electrode is also referred to as polycarbonate/graphite electrode. Additional treatment of the carbon electrode with a chaotropic agent such as urea or guanidine hydrochloride has proved advantageous.

The invention further relates to a carbon electrode for an electrochemical method for detecting an analyte, which electrode has been treated according to a method of the invention. The invention furthermore relates to the use of such a carbon electrode in a method for electrochemically detecting an analyte. The analyte may be a biomolecule, in particular a nucleic acid. The analyte may have a labeling substance that may be an enzyme that can be detected electrochemically via an enzymatic reaction or may be a redox-active substance. The labeling substance may be bound to the analyte or it may be a part of the molecule of the analyte. For example, if the analyte is a nucleic acid, the labeling substance may be a modified base such as inosine or 8-oxoguanine. It is advantageous for the analyte to be bound to the carbon electrode, specifically to a capture molecule bound to the carbon electrode, during detecting. Electrochemical detecting may be carried out, for example, by means of differential pulse voltammetry (DPV) or chronopotentiometric stripping analysis (CPSA).

Preferably, the carbon electrode is simultaneously in contact with a detergent and with the analyte during detecting. In this connection, the detergent itself should not generate a signal in the measurement range relevant to the analyte. The detergent may be added prior to, after, or during contacting the analyte with the carbon electrode to suppress and/or remove nonspecific binding to the carbon electrode. One of the advantages of the present invention is that the detergent can provide stringent conditions for binding of the analyte to the capture molecule, which virtually eliminates nonspecific binding to the carbon electrode. This is particularly advantageous if the analyte is a nucleic acid that hybridizes with the capture molecule.

The detergent is preferably an ionic detergent. It has proved advantageous for the detergent to be present at a concentration of from 0.1% w/v to 20% w/v, in particular 1% w/v to 15% w/v. The critical micellar concentration of the detergent in water is preferably less than 11 mmol/L, in particular less than 5 mmol/L, preferably less than 3 mmol/L. The detergent may be sodium dodecyl sulfate (SDS). Advantageously, the carbon electrode is stored, prior to detecting, in a solution containing the detergent. This makes it possible to use the carbon electrode for detecting immediately at any time. When used repeatedly, the electrode is preferably stored between uses in the solution containing the detergent.

For electrochemical detection, preference is given to choosing a potential interval for measurement in which essentially only the analyte causes a signal. In particular, the substance, the capture molecule and/or the detergent should be prevented from generating an electrochemical signal in the potential interval.

The invention will be further described in the following examples, which do not limit the scope of the invention described in the claims.

### EXAMPLES

### Example 1

Silanization of Pencil Electrodes

Pencil leads (from Pentel, C525-HB/Hi-Polymere, extra strong) of 60 mm in length were cut into pieces of approximately 1 cm in length. The lead pieces were incubated with gentle agitation in a solution of 1% (v/v) 3-(glycidyloxypropyl)trimethoxysilane (Fluka), 1% (v/v) demineralized water (Millipore) and 98% (v/v) ethanol (Merck) at room temperature for 1 h. The pieces were then dried at 80° C. for 30 min.

### Example 2

Coupling of Oligonucleotides as Capture Molecules to Silanized Pencil Electrodes

The silanized pencil electrodes were transferred to 1 ml of a solution containing 150 pmol/ml oligo-nucleotide in 0.1 M Na₂CO₃, pH 9.5 and incubated at room temperature (RT) for one hour. During this incubation, the free amino groups of the oligonucleotides bind covalently to the silane. Noncovalently bound oligonucleotides were removed by incubating the electrodes in 2 of 10% SDS at RT for one hour. Binding sites still available were saturated by incubating the electrodes in 1% bovine serum albumin (BSA) or ethanolamine in phosphate-buffered saline (PBS) at RT for one hour.

The oligonucleotides used were:

N-Tlk-biotin (biotin—SEQ ID No: 1-amino link): Biotin—5′ gca aca aga cca cca ctt cga aac c 3′-amino link

Tlk-biotin (biotin—SEQ ID No: 1): Biotin—5′ gca aca aga cca cca ctt cga aac c 3′

TNF2 (SEQ ID No: 2-amino link) 5′ cct icc cca atc cct tta tt 3′-amino link; (i=inosine) TNF2 is a sequence from the cDNA of the gene of human tumor necrosis factor α, provided with an amino link.

### Example 3

Optimization of Terminal Binding of the Oligo-Nucleotides as Capture Molecules to Silanized Pencil Electrodes

Pencil electrodes were coated with silane as described in example 1. The oligonucleotides were coupled by incubating the silanized electrodes in each case with biotinylated oligonucleotides with (Bio-Tlk-N) and without (Bio-Tlk) terminal amino group. The incubation was carried out as described in Example 2, the difference being that it was carried out in each case in the presence and absence of a 100-fold molar excess, compared to the oligonucleotides, of the competitor histidine. Noncovalently bound nucleic acids were removed by incubation in 10% SDS at 42° C. for 1 h. The covalently bound oligonucleotides were detected by incubating the electrodes first in 1% BSA in PBS and then in a solution of 200 ng/ml horseradish peroxidase (HPR)-streptavidine in PBS, 0.05% Tween 20 at room temperature for 30 min. The electrodes were incubated twice in 6 M urea, 0.4% SDS, 0.5×SSC (standard saline citrate) for 5 min and twice in 2×SSC. The electrodes were then transferred into wells of a microtiter plate and incubated with gentle agitation with 20 μl of TMB solution (Pierce) at room temperature. After 20 min, color development was stopped by adding 50 μl of 1M sulfuric acid. Absorption in the wells was measured at a wavelength of 450 nm and a reference wavelength of 690 nm. The absorptions of each concentration were determined in triplicate.

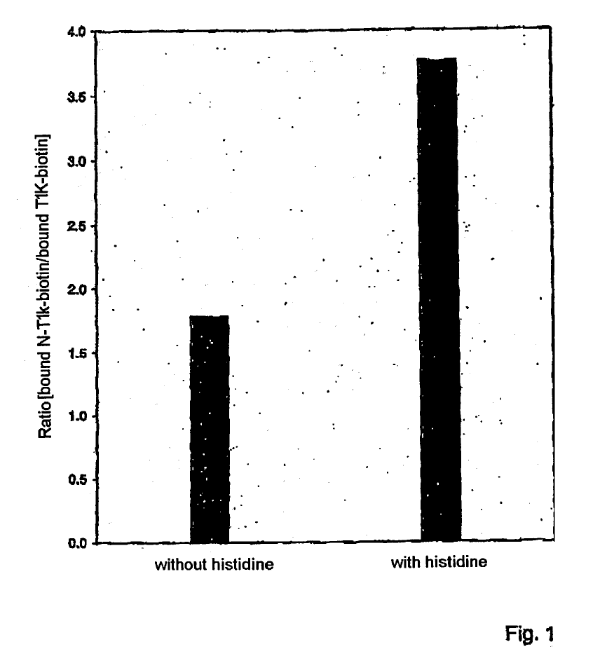

Oligonucleotides without terminal amino group were able to form in each case only undefined covalent bonds via the amino groups present in the bases. In contrast, oligonucleotides with terminal amino group can also bind covalently via this amino group. As FIG. 1 shows, the presence of the competitor increased the ratio of amino terminally bound nucleic acid to nucleic acid bound in an undefined manner by a factor greater than 2, meaning that the competitor histidine inhibits undefined covalent binding more strongly than covalent binding of the terminal amino group.

### Example 4

Determination of the Amount of Nonspecifically Bound Nucleic Acids to Uncoated Pencil Electrodes

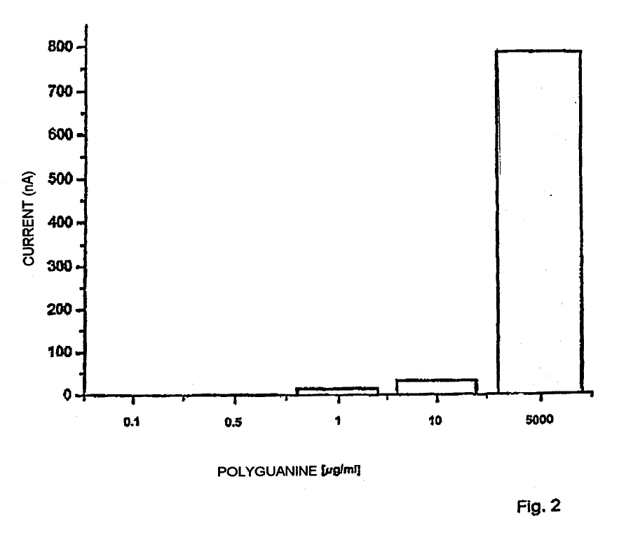

An uncoated pencil electrode was connected to an Autolab apparatus (from Eco Chemie, the Netherlands) and incubated in 0.1 M sodium acetate buffer (pH 4.6) at 1.4 V for one minute. This was followed by incubating the electrode with various concentrations of polyguanine for 5 minutes. The following concentrations were used: 5 000 μg/ml, 10 μg/ml, 1 μg/ml, 0.5 μg/ml and 0.1 μg/ml. Adsorbed polyguanine was determined in 0.1 M sodium acetate buffer (pH 4.6) by means of DPV within a potential interval of 0.6 V-1.2 V. The DPV was carried out using the following settings: modulation time: 0.05 s; time interval: 0.5 s; potential level: 0.00795 V; modulation amplitude: 0.05055 V. Guanine was oxidized at approx. 1.05 V. Polyguanine was detectable up to a concentration of 0.1 μg/ml. The result is depicted in FIG. 2.

### Example 5

Studying the Effect of Silanization on the DPV

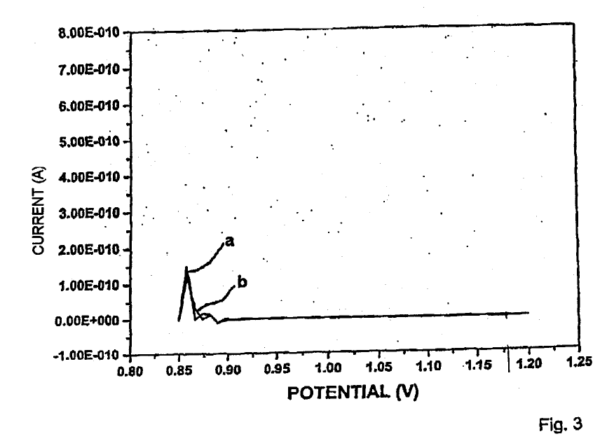

A pencil electrode was connected to an Autolab apparatus prior to and after silanization and incubated in 0.1 M sodium acetate buffer (pH 4.6) at 1.4 V for one minute. This was followed by carrying out a DPV in the potential interval of 0.6 V-1.2 V, using the settings described in Example 3. No signal was detectable in the region of the guanine oxidation potential (1 V), even at a sensitivity of less than 0.1 nA. Thus, silanization does not generate a background signal in the region of the guanine oxidation potential. Curve a in FIG. 3 depicts the result prior to and curve b depicts the result after silanization.

### Example 6

Electrochemical Detection of Desorption of Nucleic Acid Nonspecifically Bound to Carbon Electrodes by Detergent

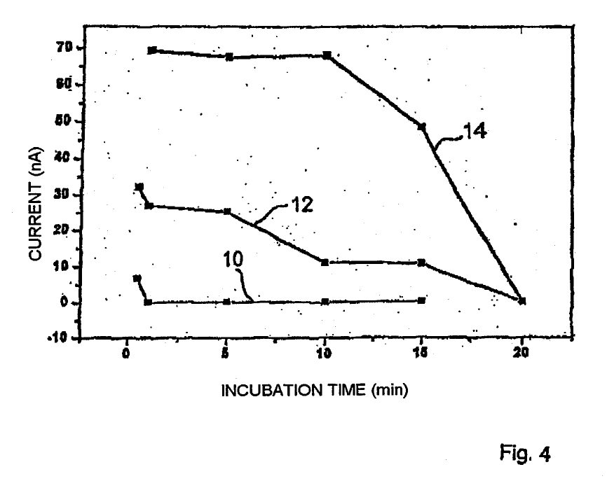

Pencil electrodes were pretreated by incubation in 10% SDS for 1 min. Nucleic acid was absorbed by incubating the electrodes in 0.1 M sodium carbonate buffer (pH 9.5) containing 1 nmol/ml of the oligonucleotide TNF2k having the sequence 5′ aat aaa ggg att ggg gca gg 3′ (SEQ ID No: 3) at room temperature for 1 h. Nonspecifically bound nucleic acid was removed by incubating the electrodes in a solution containing 1%, 5% or 10% SDS and removing them therefrom in each case after 0.5 min, 1 min, 5 min, 15 min and 20 min. The amount of nucleic acid remaining adsorbed was determined by means of DPV on the basis of guanine oxidation. As FIG. 4 illustrates, treatment with SDS was able to effectively reduce the amount of nucleic acid adsorbed. Curve 10, curve 12 and curve 14 were determined using the electrode incubated in 10% SDS, 5% SDS and 1% SDS, respectively. During treatment with 10% SDS, the amount of nucleic acid adsorbed dropped below the detection limit already after one minute.

### Example 7

Electrochemical Analysis of Inosine-Containing Nucleic Acids

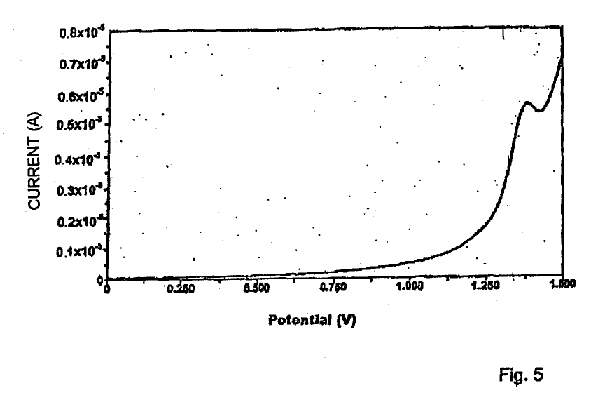

The oxidation potential of inosine was determined by treating pencil electrodes in 10% SDS for one minute and incubating them in 1, 5, 10, 50, 100, 500, 1 250 and 2 500 μg/ml polyinosine in 0.1 M sodium acetate buffer (pH 4.6) for 5 min. The electrodes were rinsed in deionized water and measured by means of DPV in the potential range from 0-1.5 V. As FIG. 5 shows, the oxidation signal of inosine is at 1.3 V and can therefore be distinguished clearly from the oxidation signal of guanine at 1.0 V.

### Example 8

Dependence of the Electrochemical Signal on Nucleic Acid Concentration

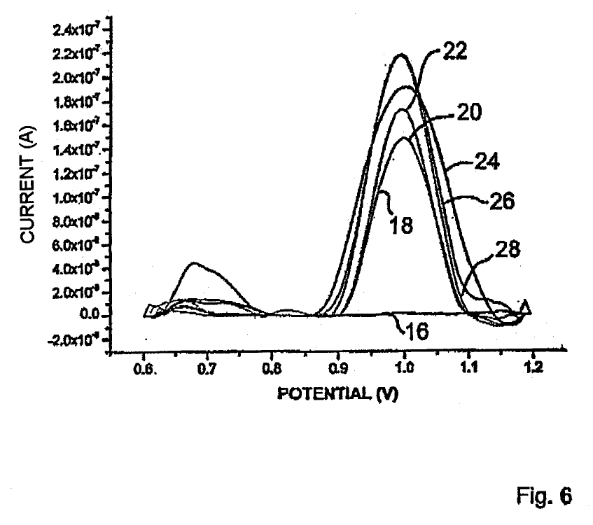

Pencil electrodes with nucleic acid TNF2 immobilized as capture molecule were preincubated in 5% SDS for one minute. The electrodes were then incubated in detergent-containing hybridization buffer (Roche) with 0.7 μg/ml, 3 μg/ml, 7 μg/ml, 10 μg/ml, 20 μg/ml and 30 μg/ml of the complementary nucleic acid TNF2k (SEQ ID No: 3) for one hour. This was followed by analyzing the electrodes by means of DPV under the conditions described in Example 4. Binding of the complementary nucleic acid was detected on the basis of guanine oxidation. As FIG. 6 shows, the signal intensity of guanine oxidation at 1 V increases as a function of increasing concentration of the complementary nucleic acid. The curves 16, 18, 20, 22, 24, 26 and 28 correspond to 0.7 μg/ml, 3 μg/ml, 7 μg/ml, 10 μg/ml, 20 μg/ml and 30 μg/ml, respectively, of the complementary nucleic acid TNF2k.

### Example 9

Effect of Electrode Treatment on the Sensitivity and Reproducibility of Electrochemical Detection of Nucleic Acids

Silanized pencil electrodes with nucleic acid TNF2 immobilized as capture molecule were prepared as described in experiment 2. Deviating from experiment 2, the electrodes were treated electrochemically (1.2 V in 0.1 M sodium acetate buffer (pH 4.6) for 1 min) or by treatment with 10% SDS for 1 min prior to silanization. After coupling the nucleic acid TNF2, the electrodes were incubated in a solution of 10 nmol/ml of the complementary nucleic acid TNF2k (SEQ ID No: 3) in detergent-containing hybridization buffer (Roche), and bound nucleic acid TNF2k was determined by means of DPV. Ten measurements each were carried out using electrochemically treated and detergent-treated electrodes, respectively. The treatment with detergent increased sensitivity by more than 10% compared with electrochemical treatment. Furthermore, measurements using detergent-treated electrodes had improved reproducibility. The standard deviation of the measurements of detergent-treated electrodes was a factor 3 less than in the case of electrochemical treatment.

### Example 10

Activation of Polycarbonate/Graphite Electrodes by SDS Treatment

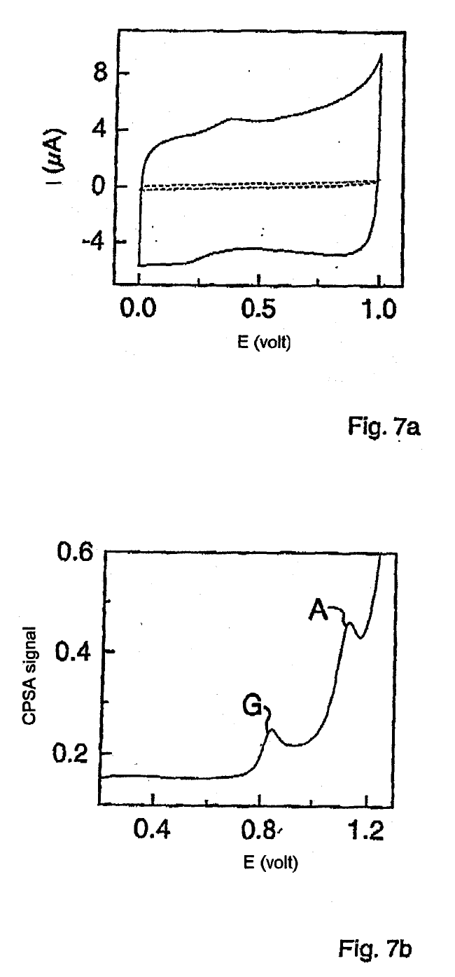

In FIG. 7a, the dashed line shows a cyclovoltammogram recorded prior to and the solid line shows a cyclovoltammogram recorded after treatment of a polycarbonate/graphite electrode. Treatment was carried out by incubating in 10% SDS at 80° C. for 30 min. The cyclovoltammogram recorded after treatment indicates by an increased capacitive current that a distinctly larger electroactive surface is available than without treatment.

FIG. 7b shows the result of a CPSA of 200 μg/ml herring sperm DNA solution in 0.1 M sodium acetate (pH 4.7). The CPSA was carried out using a polycarbonate/graphite electrode which had been treated beforehand with 10% SOS at 80° C. for 30 min under the following conditions: 30 s of accumulation, 30 μA of constant oxidation current in 1 M sodium acetate buffer (pH 6.0). As FIG. 7 illustrates, a distinct signal of guanine oxidation at 0.8 V (peak indicated by G) and adenine oxidation (peak indicated by A) at 1.1 V was measured after treatment. Using a polycarbonate/graphite electrode that had been electrochemically pretreated instead, it was not possible to measure an oxidation signal.

### Example 11

Comparison of the Sensitivity of Polycarbonate/Graphite and Pyrolytic Graphite Electrodes

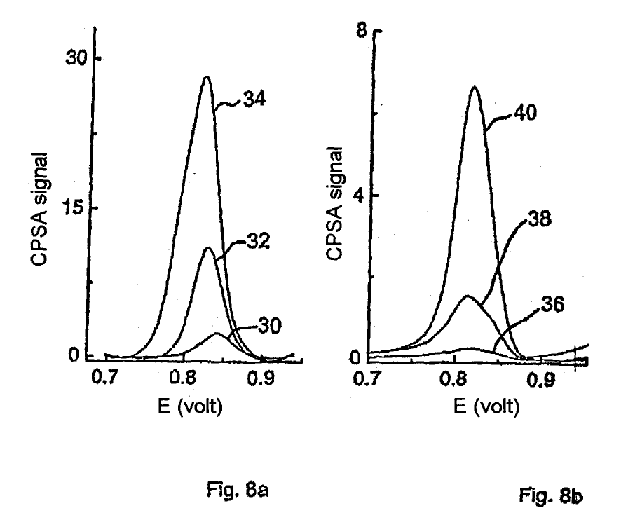

A concentration series of 1, 10 and 100 μg/ml herring sperm DNA was analyzed by means of CPSA on the basis of the guanine oxidation signal. The electrodes used were a pyrolic graphite electrode electrochemically treated at 1.7 V for 60 s and a polycarbonate/graphite electrode treated with 10% SDS at 80° C. in FIGS. 8a and 8b, the curves 30 and 36 correspond in each case to 1 μg/ml, the curves 32 and 38 correspond in each case to 10 μg/ml and the curves 34 and 40 correspond in each case to 100 μg/ml of herring sperm DNA. The signal size is proportional to the amount of DNA. The sensitivity of the SDS-treated polycarbonate/graphite electrode is increased compared with that of the electrochemically treated pyrolytic graphite electrode.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method to increase the sensitivity of a carbon electrode for electrochemically detecting an analyte without electrochemically conditioning the carbon electrode, comprising treating the carbon electrode with an ionic detergent, wherein the ionic detergent is in solution, wherein the detergent is not incorporated in a coating of the electrode.

2. The method of claim 1, wherein the concentration of the detergent is from 0.1% w/v to 20% w/v.

3. The method of claim 1, wherein the concentration of the detergent is from 1% w/v to 15% w/v.

4. The method of claim 1, wherein a critical micellar concentration of the detergent in water is less than 11 mmol/L.

5. The method of claim 1, wherein a critical micellar concentration of the detergent in water is less than 5 mmol/L.

6. The method of claim 1, wherein a critical micellar concentration of the detergent in water is less than 3 mmol/L.

7. The method of claim 1, wherein the detergent is sodium dodecyl sulfate (SDS).

8. The method of claim 1, wherein the carbon electrode is coated with a substance.

9. The method of claim 8, wherein the substance is an electrochemically substantially inert substance.

10. The method of claim 9, wherein the substance is a silane.

11. The method of claim 10, wherein the silane is 3-(glycidyloxypropyl) trimethoxysilane.

12. The method of claim 9, wherein a molecule is bound to the carbon electrode.

13. The method of claim 12, wherein the molecule is bound to the substance.

14. The method of claim 12, wherein the molecule is bound directionally.

15. The method of claim 14, wherein the directionally bound molecule is bound to the carbon electrode at one end of the molecule.

16. The method of claim 12, wherein the molecule is bound covalently.

17. The method of claim 14, wherein the quotient of the amount of the molecules bound directionally and the amount of the molecules that are not bound directionally is greater than 1.

18. The method of claim 17, wherein the quotient is greater than 3.

19. The method of claim 12, wherein the molecule is bound to the carbon electrode in the presence of a competitor.

20. The method of claim 19, wherein the competitor is a protein or an amino acid.

21. The method of claim 12, wherein the molecule is a capture molecule, wherein the capture molecule specifically binds the analyte.

22. The method of claim 21, wherein the capture molecule is a nucleic acid, a nucleic acid analog, a ligand, a hapten, a peptide, a protein, a sugar, or a lipid.

23. The method of claim 22, wherein the nucleic acid is single-stranded.

24. The method of claim 23, wherein the single-stranded nucleic acid comprises at least one nucleotide having a modified base, wherein the modified base generates a signal during electrochemical detecting that is different from that generated by nucleotides of the analyte.

25. The method of claim 24, wherein the modified base is inosine or 8-oxoguanine.

26. The method of claim 23, wherein the single-stranded nucleic acid has no guanine and/or adenine residues.

27. The method of claim 21, wherein the carbon electrode is treated with the ionic detergent prior to, during, or after binding of the analyte to the capture molecule.

28. The method of claim 1, wherein the carbon electrode is a pencil electrode, a glassy carbon electrode, a pyrolytic graphite electrode or a plastic composite electrode.

29. The method of claim 28, wherein the carbon electrode is a graphite-containing polycarbonate electrode.

30. The method of claim 1, wherein the carbon electrode is additionally treated with a chaotropic agent.

31. The method of claim 30, wherein the chaotropic agent is urea or guanidine hydrochloride.

32. A carbon electrode for electrochemically detecting an analyte, wherein the electrode has been treated according to the method of claim 1.
